(19) United States
(12) Patent Application Publication
(10) Pub. No.: US 2026/0146886 A1
(43) Pub. Date: May 28, 2026

(54) DISTRIBUTED ACOUSTIC SENSING DEVICE AND METHOD BASED ON LINEAR FREQUENCY MODULATION PULSE SEQUENCE

(71) Applicant: Taiyuan University of Technology, Taiyuan City (CN)

(72) Inventors: Zhe MA, Taiyuan City (CN); Mingjiang ZHANG, Taiyuan City (CN); Rui LI, Taiyuan City (CN); Jianzhong ZHANG, Taiyuan City (CN); Jian LI, Taiyuan City (CN); Jinpeng KONG, Taiyuan City (CN)

(21) Appl. No.: 19/392,711

(22) Filed: Nov. 18, 2025

(30) Foreign Application Priority Data
Nov. 27, 2024 (CN) 202411710940.X

(51) Int. Cl. G01H 9/00; G01D 5/353

(52) U.S. Cl. CPC G01H 9/004; G01D 5/35329; G01D 5/35361

(57) ABSTRACT

A device includes a narrow linewidth laser, a dual-parallel Mach-Zehnder modulator and an arbitrary waveform generator. The arbitrary waveform generator is connected to the dual-parallel Mach-Zehnder modulator, and is configured to generate the linear frequency modulation pulse sequence including a plurality of pulses with sequentially increased or decreased central frequencies, so as to drive the dual-parallel Mach-Zehnder modulator. A laser transmitted by the narrow linewidth laser is divided into two parts, one part serves as reference light, and the other part, as signal light, is modulated into the linear frequency modulation pulse sequence by the dual-parallel Mach-Zehnder modulator and then output to a sensing optical fiber. Rayleigh backscattered light generated in the sensing optical fiber interferes with the reference light. An interference signal is detected by a balanced photodetector and subsequently acquired by an acquisition card.

### TECHNICAL FIELD

The present disclosure belongs to the technical field of optical fiber distributed sensing, and discloses a distributed acoustic sensing device and method based on a linear frequency modulation pulse sequence. A detection light pulse is modulated into a linear frequency modulation pulse sequence with center frequency scanning by phase modulation, and frequency shift and time shift features are demodulated by a pulse recombination demodulation algorithm and a cyclic calibration correlation method, so that dynamic strain demodulation with high resolution and large measurement range can be achieved.

### BACKGROUND

Distributed acoustic sensing (DAS) technology is an advanced sensing technology that uses Rayleigh backscattering in optical fibers to position and recover the change of environmental physical quantities at any position of an optical fiber link, and is widely applied to health monitoring of large-scale infrastructures such as oil and gas pipelines, bridges and tunnels, and traffic tracks. However, since a scattering medium in the optical fiber is affected by the environment, interference fading of scattered signals in a DAS system will inevitably occur in the coherent superposition process, resulting in high signal randomness, insufficient signal-to-noise ratio and sensitivity, and difficult achievement of high-resolution large-range measurement.

To eliminate the influence of interference fading on the signal, the linear frequency modulation technology is introduced into the DAS system due to the advantages of continuous waveform and pulse waveform. By combining the linear frequency modulation pulse with a matched filtering algorithm, the problem of the trade-off between the sensing distance and the space resolution can be solved while the signal interference fading is suppressed (CN107990970 B). The linear frequency modulation pulse technology is combined with a Rayleigh scattering pattern method, and demodulation is performed through cross-correlation operation, so that the strain resolution of ne order can be achieved while the interference fading is suppressed (Optics Express, 2016, 24(12): 13121-13133). However, the maximum single strain measurement value of the linear frequency modulation pulse scheme is limited by the modulation bandwidth of the linear frequency modulation pulse, thereby having extremely high requirements on device indexes. Therefore, a frequency scanning scheme is proposed. At present, linear strain response as low as 47.5 pε can be achieved by using a frequency scanning coherent light time domain reflection technology (Optics Express, 2018, 26(8): 10573-10588.). However, to achieve high-resolution strain measurement, it is necessary for a frequency scanning system to reduce a frequency scanning step, thereby prolonging the measurement period and reducing the frequency response range of the dynamic strain. However, increasing the frequency scanning step will further limit the strain resolution.

When the dynamic strain changes slightly, through long-time continuous measurement, the differential increment accumulation of the cross-correlation results can effectively enlarge the strain measurement range of the system, but the limitation of the maximum single strain measurement value still exists. For the traditional linear frequency modulation pulse DAS system, the maximum single strain measurement value and the strain resolution are mutually restricted. Increasing the modulation bandwidth of the linear frequency modulation pulse results in the reduction of the strain sensitivity. This limitation hinders the full utilization of the performance of system hardware. Therefore, solving the problem of the contradiction between the maximum single strain measurement value and the strain resolution is the key to improving the performance of the DAS system of the linear frequency modulation pulse.

### SUMMARY

For the existing problem of the contradiction between the maximum single strain measurement value and the strain resolution in a DAS system, the present disclosure provides a distributed acoustic sensing device and method based on a linear frequency modulation pulse sequence. On the promise of not increasing hardware configuration of the system, high strain sensitivity is retained and the ability to measure a large strain is improved.

To solve the above technical problem, the present disclosure adopts the following technical solution: a distributed acoustic sensing device based on a linear frequency modulation pulse sequence includes a narrow linewidth laser, a dual-parallel Mach-Zehnder modulator, a single-mode optical fiber, an arbitrary waveform generator, a balanced photodetector and an acquisition card, where the arbitrary waveform generator is connected to the dual-parallel Mach-Zehnder modulator, and is configured to generate the linear frequency modulation pulse sequence to drive the dual-parallel Mach-Zehnder modulator; the linear frequency modulation pulse sequence output by the arbitrary waveform generator includes a plurality of pulses with sequentially increased or decreased central frequencies;

laser transmitted by the narrow linewidth laser is divided into two parts; one part serves as reference light, and the other part, as signal light, is modulated into the linear frequency modulation pulse sequence by the dual-parallel Mach-Zehnder modulator driven by the arbitrary waveform generator; the linear frequency modulation pulse sequence is output to a sensing optical fiber; Rayleigh backscattered light generated in the sensing optical fiber and the reference light are jointly sent to a 2×1 polarization-maintaining coupler for interference; an interference signal is detected by the balanced photodetector; and the acquisition card is configured to acquire a detection signal output by the balanced photodetector.

The distributed acoustic sensing device based on the linear frequency modulation pulse sequence further includes a 1*2 polarization-maintaining coupler, a first erbium-doped fiber amplifier, an optical circulator and a second erbium-doped fiber amplifier.

Laser transmitted by the narrow linewidth laser is divided into two parts by the 1*2 polarization-maintaining coupler; one part serves as signal light and the other part serves as reference light; the signal light is modulated into the linear frequency modulation pulse sequence by the dual-parallel Mach-Zehnder modulator driven by the arbitrary waveform generator; the linear frequency modulation pulse sequence is amplified by the first erbium-doped fiber amplifier and then output to the sensing optical fiber by the optical circulator; Rayleigh backscattered light generated in the sensing optical fiber is output by the optical circulator; and the output Rayleigh backscattered light is amplified by the second erbium-doped fiber amplifier and then sent to the 2*1 polarization-maintaining coupler together with the reference signal for interference.

The narrow linewidth laser is configured to output laser with a central wavelength of 1550 nm.

The linear frequency modulation pulse sequence output by the arbitrary waveform generator includes 20 pulses with a center frequency interval of 10 MHz and a modulation bandwidth of 60 MHz.

The arbitrary waveform generator is also connected to the acquisition card and configured to generate a trigger signal during the transmission of each group of linear frequency modulation pulse sequence to drive the acquisition card for data acquisition.

The first erbium-doped fiber amplifier is a pulsed erbium-doped fiber amplifier, and the second erbium-doped fiber amplifier is a small-signal erbium-doped fiber amplifier.

In addition, the present disclosure further provides a distributed acoustic sensing method based on a linear frequency modulation pulse sequence, implemented on the basis of the distributed acoustic sensing device based on a linear frequency modulation pulse sequence, and including the following steps:
Step 1: acquiring data by the acquisition card, and extracting a pulse sequence frequency shift matrix and a linear frequency modulation pulse time shift matrix;
Step 2: recombining the pulse sequence frequency shift matrix by a pulse recombination algorithm according to a pulse injection order to obtain a pulse sequence frequency spectrum at any optical fiber position; dividing the pulse sequence frequency spectrum into multiple segments according to time, extracting n curves within each time segment, and performing cross-correlation operation on the last curve within each time segment and a reference curve to calculate a relative frequency shift and obtain a relative frequency shift quantity with each time segment; calculating a frequency shift quantity within each time segment according to the relative frequency shift quantity, and calculating an equivalent strain value according to the frequency shift quantity to obtain a first time-strain curve at each optical fiber position; calculating the average of strain values at different times as a first average value according to the obtained first time-strain curve;
Step 3: extracting a scattered signal corresponding to a single linear frequency modulation pulse in the linear frequency modulation pulse time shift matrix, determining whether the scattered signal at each position is distorted or not according to a distortion determination function, if not, performing local cross-correlation calculation by a sliding window to obtain a time shift of a signal envelope and converting the time shift into a strain value to obtain a time-strain curve at each optical fiber position, and if yes, performing interpolation calculation by the first average value obtained in Step 2 to obtain a time-strain curve of the optical fiber position; calculating the average of strain values at each optical fiber position at different times as a second average value, and subtracting the second average value from the obtained time-strain curve to obtain a second time-strain curve at each optical fiber position; repeatedly extracting scattered signals corresponding to other single linear frequency modulation pulses, performing calculation to obtain a second time-strain curve corresponding to each position, and averaging the second time-strain curves obtained through demodulation of different linear frequency modulation pulses to serve as a third time-strain curve; and
Step 4: adding the first average value to the third time-strain curve obtained in Step 3 to serve as a final strain demodulation result.

In Step 2, the relative frequency shift is calculated by performing cross-correlation operation on the last curve within each time segment and the first curve.

In Step 3, the distortion determination function is as follows:

$${R}_{{t}_{0}} ( z - {z}_{xcorr} , z + {z}_{xcorr} ) = {\{ \frac{1}{2 k + 1} {\sum }_{i = - k}^{k} {[ {E}_{{t}_{0}} ( z - {z}_{xcorr} , z + {z}_{xcorr} ) - {E}_{{t}_{i}} ( z - {z}_{xcorr} , z + {z}_{xcorr} ) ]}^{2} \}}^{\frac{1}{2}} ,$$

where Rₜ_{₀} (z−z_{xcorr}, z+z_{xcorr}) represents a distortion parameter at the position z at the time t₀, k is used to specify the length of time participating in calculation and capable of being selected according to the actual calculation quantity, Eₜ_{₀} (z−z_{xcorr}, z+z_{xcorr}) represents a light intensity curve from the optical fiber position z−z_{xcorr} to the optical fiber position z+z_{xcorr} at the time t₀, Eₜ_{₁} (z−z_{xcorr}, z+z_{xcorr}) represents a light intensity curve from the optical fiber position z−z_{xcorr} to the optical fiber position z+z_{xcorr} at the time t₁, and z_{xcorr} is set as a space resolution; and
when the distortion parameter R>0.5, distortion is determined.

In Step 2, the recombination method is as follows: extracting a Rayleigh backscattered light intensity curve I(Δv) obtained at any optical fiber position z along a frequency shift axis of the pulse sequence, and dividing and recombining data of different frequency scanning periods to obtain the pulse sequence frequency spectrum.

Compared with the prior art, the present disclosure has the following beneficial effects:

(1) according to the present disclosure, based on the phase compensation effect, after the strain is applied to the optical fiber, a local time shift feature is generated on a Rayleigh backscattering time-space distribution map of the linear frequency modulation pulse, and high-resolution strain measurement can be achieved through the cross-correlation operation on the local time shift feature, thereby solving the problem of interference fading of the traditional phase sensitive optical time domain reflection technology.

(2) The present disclosure provides a dynamic strain measurement method based on the linear frequency modulation pulse sequence. The technology combines the advantages of frequency scanning and the linear frequency modulation pulse, and makes full use of the sensitivity of digital modulation, so that sensing measurement with large dynamic strain range and high resolution can be achieved.

(3) The present disclosure provides a dynamic strain demodulation method based on the linear frequency modulation pulse sequence. The distortion value of the linear frequency modulation pulse can be effectively screened, value prediction is performed according to the calculation result of the frequency scanning matrix, the strain measurement range of the system is enlarged by the cyclic calibration correlation method, and the dynamic strain measurement with large range and high resolution is finally achieved.

In conclusion, the present disclosure provides a distributed optical fiber dynamic strain sensing method based on the linear frequency modulation pulse sequence. A detection light pulse is modulated through phase modulation into the linear frequency modulation pulse sequence with center frequency scanning, and the frequency shift feature generated on the scanning pulse sequence spectrogram and the time shift feature generated on the RBS time-space distribution map are demodulated by the pulse recombination demodulation algorithm and the cyclic calibration correlation method, so that dynamic strain demodulation with high resolution and large measurement range is achieved, and the problem of contradiction between the interference fading, the strain resolution of the linear frequency modulation DAS system and the strain measurement distance, thereby achieving dynamic strain demodulation with high resolution and large measurement range

### BRIEF DESCRIPTION OF THE DRAWINGS

FIG. 1 is a structural schematic diagram of a distributed acoustic sensing device based on a linear frequency modulation pulse sequence according to Embodiment 1 of the present disclosure;

FIG. 2 is a schematic flow chart of a distributed acoustic sensing method based on a linear frequency modulation pulse sequence according to Embodiment 2 of the present disclosure;

FIG. 3 is a raw data map and a pulse recombination map extracted in Embodiment 2 of the present disclosure; and

FIG. 4 is the result of recombination demodulation of dynamic strains with amplitudes of 80με 420με by the method in Embodiment 2.

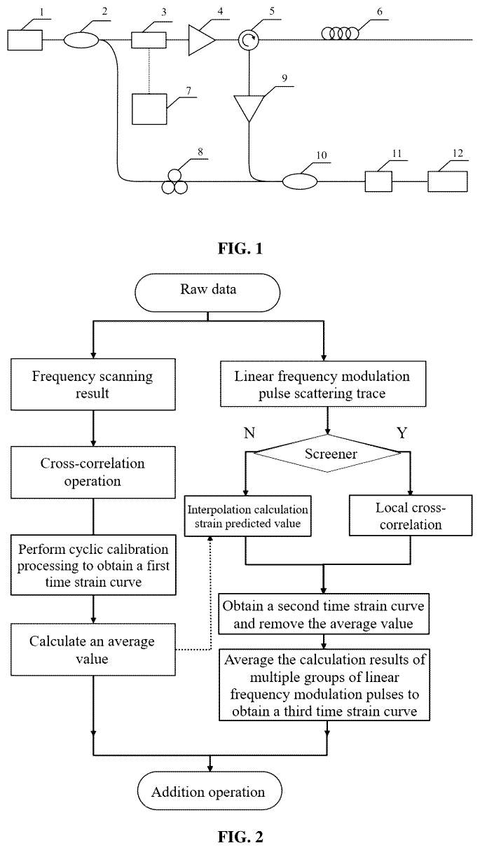

In FIG. 1, 1 is narrow linewidth laser, 2 is 1*2 polarization-maintaining coupler, 3 is dual-parallel Mach-Zehnder modulator, 4 is first erbium-doped fiber amplifier, 5 is optical circulator, 6 is single-mode optical fiber, 7 is arbitrary waveform generator, 8 is polarization controller, 9 is second erbium-doped fiber amplifier, 10 is 2*1 polarization-maintaining coupler, 11 is balanced photodetector, and 12 is acquisition card.

### DETAILED DESCRIPTION OF THE EMBODIMENTS

To make the objectives, technical solutions and advantages of the embodiments of the present disclosure clearer, the technical solutions in the embodiments of the present disclosure will be described clearly and completely below. Obviously, the described embodiments are some rather than all of the embodiments of the present disclosure. Based on the embodiments of the present disclosure, all other embodiments obtained by those of ordinary skill in the art without creative efforts shall fall within the protection scope of the present disclosure.

### Embodiment 1

As shown in FIG. 1, Embodiment 1 of the present disclosure provides a distributed acoustic sensing device based on a linear frequency modulation pulse sequence, including: a narrow linewidth laser 1, a 1*2 polarization-maintaining coupler 2, a dual-parallel Mach-Zehnder modulator 3, a first erbium-doped fiber amplifier 4, an optical circulator 5, a single-mode optical fiber 6, an arbitrary waveform generator 7, a polarization controller 8, a second erbium-doped fiber amplifier 9, a 2*1 polarization-maintaining coupler 10, a balanced photodetector 11 and an acquisition card 12, where the arbitrary waveform generator 7 is connected to the dual-parallel Mach-Zehnder modulator 3, and is configured to generate the linear frequency modulation pulse sequence to drive the dual-parallel Mach-Zehnder modulator 3; the linear frequency modulation pulse sequence output by the arbitrary waveform generator 7 includes a plurality of pulses with sequentially increased or decreased central frequencies;
laser transmitted by the narrow linewidth laser 1 is divided into two parts by the polarization-maintaining coupler 2; one part serves as signal light and the other part serves as reference light; the signal light is modulated into the linear frequency modulation pulse sequence by the dual-parallel Mach-Zehnder modulator 3 driven by the arbitrary waveform generator 7; the linear frequency modulation pulse sequence is amplified by the first erbium-doped fiber amplifier 4 and then output to the sensing optical fiber 6 by the optical circulator 5; Rayleigh backscattered light generated in the sensing optical fiber 6 is output by the optical circulator 5; the output Rayleigh backscattered light is amplified by the second erbium-doped fiber amplifier 9 and then sent to the 2*1 polarization-maintaining coupler 10 together with the reference signal for interference; an interference signal is detected by the balanced photodetector 11; and the acquisition card 12 is configured to acquire a detection signal output by the balanced photodetector 11.

Specifically, in this embodiment, the narrow linewidth laser 1 is configured to output laser with a central wavelength of 1550 nm and a linewidth of less than 1 kHz. Specifically, the central wavelength is 1550.12 nm.

Specifically, in this embodiment, the linear frequency modulation pulse sequence output by the arbitrary waveform generator 7 includes 20 pulses with a center frequency interval of 10 MHz and a modulation bandwidth of 60 MHz. In this embodiment, the modulation frequency of the first pulse of the linear frequency modulation pulse sequence is 50 MHz to 110 MHz, the modulation frequency of the second pulse is 60 MHz to 120 MHz, and so on. The pulse period is 110 μs, the pulse width is 100 ns, and the total period of the pulse sequence is 2200 μs.

Specifically, in this embodiment, the arbitrary waveform generator 7 is also connected to the acquisition card 12 and configured to generate a trigger signal during the transmission of each group of linear frequency modulation pulse sequence to drive the acquisition card 12 for data acquisition, and the acquisition card can determine the center frequency of each linear frequency modulation pulse.

The first erbium-doped fiber amplifier 4 is a pulsed erbium-doped fiber amplifier, and the second erbium-doped fiber amplifier 9 is a small-signal erbium-doped fiber amplifier.

Specifically, in this embodiment, the distributed acoustic sensing device further includes a polarization controller 8, the polarization state of the reference light is controlled by the polarization controller 8 to achieve the best interference effect, a Rayleigh backscattered signal output by the optical circulator 5 is amplified by the second erbium-doped fiber amplifier 9 and interferes with the reference light in the 2*1 polarization-maintaining coupler 10, the balanced photodetector 11 converts an optical signal output by the coupler into an electrical signal, the electrical signal is acquired by the acquired card 12, and the sampling rate is 1 GSa/s.

### Embodiment 2

As shown in FIG. 2, Embodiment 2 of the present disclosure provides a distributed acoustic sensing method based on a linear frequency modulation pulse sequence, implemented on the basis of the distributed acoustic sensing device based on the linear frequency modulation pulse sequence, and including the following steps:

Step 1: data is acquired by the acquisition card 12, and a pulse sequence frequency shift matrix and a linear frequency modulation pulse time shift matrix are extracted.

In this embodiment, the linear frequency modulation pulse sequence output by the dual-parallel Mach-Zehnder modulator 3 is amplified by the first erbium-doped fiber amplifier 4 and then injected into the single-mode optical fiber 6 with the length of 10.45 km by the optical circulator 5, and a strain is applied at the optical position from 10385 m to 10395 m by a piezoelectric ceramic tube or a mechanical stretching device. Measurements are performed respectively when sinusoidal dynamic strains with the amplitudes of 80με and 420με are applied to the position.

Step 2: the pulse sequence frequency shift matrix is recombined by a pulse recombination algorithm according to a pulse injection order to obtain a pulse sequence frequency spectrum at any optical fiber position; the pulse sequence frequency spectrum is divided into multiple segments according to time, n curves within each time segment are extracted, and cross-correlation operation is performed on the last curve within each time segment and a reference curve to calculate a relative frequency shift and obtain a relative frequency shift quantity with each time segment; a frequency shift quantity within each time segment is calculated according to the relative frequency shift quantity, and an equivalent strain value is calculated according to the frequency shift quantity to obtain a first time-strain curve at each optical fiber position; and the average of strain values at different times is calculated as a first average value according to the obtained first time-strain curve.

Specifically, in Step 2, the relative frequency shift is calculated by performing cross-correlation operation on the last curve within each time segment and the first curve.

In Step 2, the recombination method is as follows: extracting a Rayleigh backscattered light intensity curve I(Δv) obtained at any optical fiber position z along a frequency offset axis of the pulse sequence, and dividing and recombining data of different frequency scanning periods to obtain the pulse sequence frequency spectrum.

Step 3: a scattered signal corresponding to a single linear frequency modulation pulse in the linear frequency modulation pulse time shift matrix is extracted, whether the scattered signal at each position is distorted or not is determined according to a distortion determination function, if not, local cross-correlation calculation is performed by a sliding window to obtain a time shift of a signal envelope and converting the time shift into a strain value to obtain a time-strain curve at each optical fiber position, and if yes, interpolation calculation is performed by the first average value obtained in Step 2 to obtain a time-strain curve of the optical fiber position; the average of strain values at each optical fiber position at different times is calculated as a second average value, and the second average value is subtracted from the obtained time-strain curve to obtain a second time-strain curve at each optical fiber position; and scattered signals corresponding to other single linear frequency modulation pulses are repeated extracted, calculation is performed to obtain a second time-strain curve corresponding to each optical fiber position, and the second time-strain curves obtained through demodulation of different linear frequency modulation pulses are averaged to serve as a third time-strain curve.

Specifically, in Step 3, the distortion determination function is as follows:

$$( 1 )$$

$${R}_{{t}_{0}} ( z - {z}_{xcorr} , z + {z}_{xcorr} ) = {\{ \frac{1}{2 k + 1} {\sum }_{i = - k}^{k} {[ {E}_{{t}_{0}} ( z - {z}_{xcorr} , z + {z}_{xcorr} ) - {E}_{{t}_{i}} ( z - {z}_{xcorr} , z + {z}_{xcorr} ) ]}^{2} \}}^{\frac{1}{2}}$$

where Rₜ_{₀} (z−z_{xcorr}, z+z_{xcorr}) represents a distortion parameter at the position z at the time t₀, k is used to specify the length of time participating in calculation and capable of being selected according to the actual calculation quantity, Eₜ_{₀} (z−z_{xcorr}, z+z_{xcorr}) represents a light intensity curve from the optical fiber position z−z_{xcorr} to the optical fiber position z+z_{xcorr} at the time t₀, Eₜ_{₁} (z−z_{xcorr}, z+z_{xcorr}) represents a light intensity curve from the optical fiber position z−z_{xcorr} to the optical fiber position z+z_{xcorr} at the time t₁, and z_{xcorr} is generally set as a space resolution. In this embodiment, the distortion determination function achieves data screening by calculating the similarity of the intensity envelope of the local Rayleigh backscattered light in the aspect of time, and the strain measurement range can be enlarged by using interpolation calculation on the distorted data part.

Specifically, when the distortion parameter R at the position z is greater than 0.5, it is determined that the data here is distorted.

Step 4: the first average value is added to the third time-strain curve obtained in Step 3 to serve as a final strain demodulation result.

In this embodiment, after the linear frequency modulation pulse sequence is injected into the sensing optical fiber by the dual-parallel Mach-Zehnder modulator, the raw data acquired by the acquisition card is the combination of the pulse sequence frequency shift matrix and the linear frequency modulation pulse time shift matrix.

In Step 2, the raw data can be recombined according to the pulse injection order by the pulse recombination algorithm. A Rayleigh backscattered light intensity curve I(Δv) obtained at any optical fiber position z=t₂c₀/(2n_{g}) is extracted along a frequency offset Δvₚ of the pulse sequence, and data of different frequency scanning periods is divided and recombined into the pulse sequence frequency spectrum, where z is the optical fiber position, t_{z} is the acquisition time c₀ corresponding to the optical fiber position z, c₀ is a light speed in vacuum, and n_{g} is a refractive index of the optical fiber. Frequency shift occurs in the frequency spectrum after the sensing optical fiber is subjected to a stress. The frequency shift Δvₚ can be obtained by performing cross-correlation calculation on the Rayleigh backscattered light intensity curves I(Δv) at different times, and can be equivalently converted into a strain value Δε by the following formula:

$$Δε = - \frac{1}{0.78} \frac{Δ {v}_{p}}{{v}_{0}} , \qquad ( 2 )$$

where v₀ represents the initial central light frequency of the pulse.

Further, in this embodiment, to increase the strain measurement range, the frequency spectrum of the pulse sequence is divided into segments according to time, there are n curves within each time segment, each curve within the segment and a reference curve I₀(Δv) (usually the first curve within the segment) are subjected to cross-correlation operation to calculate the relative frequency shift change, the frequency shift calculation value of the nₜₕ curve Iₙ(Δv) serves as a calibration value, and the frequency shift calculation results of the next time segment are uniformly added with the frequency shift calibration values of the previous times. After cyclic calibration, the frequency shift quantity Δv_{d} with each time segment is obtained and can be represented as:

$$Δ {v}_{d} = max \{ correlation [ {I}_{0} ( Δ v ) , {I}_{n} ( Δ v ) ] \} + {v}_{c} , \qquad ( 3 )$$

where v_{c} is the calibration value. In this embodiment, the calculation error in the traditional differential increment method can be reduced to a certain extent through the cyclic calibration. Meanwhile, due to the few frequency scanning points of the system, the calculation quantity of the cross-correlation operation is relatively small. Further, the calculation results of the frequent shift quantities at each time segment obtained by the cyclic calibration method is subjected to segmented averaging, so that the calculation error in the cross-correlation process can be reduced.

In addition, in this embodiment, since the pulses in the linear frequency modulation pulse sequence are simultaneously modulated into the linear frequency modulation pulses with the center frequency of vₚ and the bandwidth of δv, for the linear frequency modulation pulse time shift matrix, the Rayleigh backscattered light intensity curve with a certain frequency is extracted along an optical fiber time (distance) axis t_{z} and denoted as T(τₛ). When the optical fiber is subjected to strain, a local Rayleigh backscattering pattern shifts along the optical fiber time (distance) axis t_{z}. A time (corresponding to the optical fiber position) offset Δt can be obtained by performing sliding window cross-correlation analysis on the local Rayleigh backscattered light intensity envelope. The relationship between the time (corresponding to the optical fiber position) offset and an equivalent strain value Δε can be expressed as:

$$Δε = - \frac{1}{0.78} \frac{1}{{v}_{0}} \frac{δ v}{{τ}_{p}} Δ t , \qquad ( 4 )$$

where τₚ represents the time width of the pulse.

In Step 3, when the strain applied to the optical fiber is too large, the scattered signal pattern extracted by the linear frequency modulation pulse time shift matrix will be distorted. In this embodiment, data screening is achieved by calculating the similarity of the local Rayleigh backscattered light intensity envelope in the aspect of time, the distortion determination function is defined, a distortion measurement value is screened out by taking 0.5 as a threshold, and interpolation calculation is performed by combining with the strain demodulation result of the pulse sequence at the corresponding time to obtain a strain predicted value, so that the demodulation distortion of the linear frequency modulation pulse time shift matrix when the strain is too large can be avoided.

In Step 4, the strain calculation values obtained by the single pulse in the linear frequency modulation pulse time shift matrix are averaged to obtain a second average value, and then a strain change curve with high resolution can be obtained by removing the second average value from the strain calculation values. Further, the strain change curves of the pulses with different central frequencies in the linear frequency modulation pulse sequence are averaged, so that the strain measurement error can be further reduced. The strain corresponding to the time shift can be calculated according to a formula 4. Finally, a strain demodulation value with high resolution and large range of the system is obtained through addition operation.

As shown in FIG. 3, (a) represents a raw data map, (b) represents a pulse sequence spectrum after recombination at the optical fiber position 10390 m, and (c) represents the linear frequency modulation pulse time shift matrix diagram after recombination.

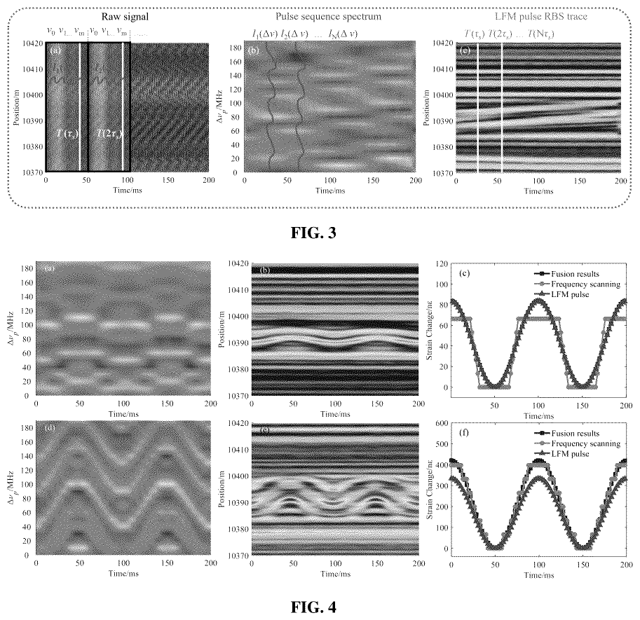

As shown in FIG. 4, it is a comparative schematic diagram of various demodulation methods when sinusoidal dynamic strains with the amplitudes of 80 με and 420 με are applied to the optical fiber position from 10385 m to 10395 m by a piezoelectric ceramic tube or a mechanical stretching device, where (a) represents a pulse sequence spectrum after recombination at the optical fiber position 10390 m when the sinusoidal dynamic strain with the amplitudes of 80 με is applied; (b) is a linear frequency modulation pulse time shift matrix diagram after recombination when the sinusoidal dynamic strain with the amplitudes of 80 με is applied; (c) represents the demodulation result of the pulse sequence and the linear frequency modulation pulse as well as the final combination result when the sinusoidal dynamic strain with the amplitudes of 80 με is applied; (d) represents a pulse sequence spectrum after recombination at the optical fiber position 10390 m when the sinusoidal dynamic strain with the amplitudes of 420 με is applied; (e) represents a linear frequency modulation pulse time shift matrix diagram after recombination when the sinusoidal dynamic strain with the amplitudes of 420 με is applied; and (f) represents the demodulation result of the pulse sequence and the linear frequency modulation pulse as well as the final combination result when the sinusoidal dynamic strain with the amplitudes of 420 με is applied. It can be found that when the strain amplitude is small, the resolution of the linear frequency modulation pulse demodulation result is low, and the pulse sequence demodulation result shows a stepped pattern due to the insufficient resolution; and when the strain amplitude is large, the linear frequency modulation pulse measurement result is distorted, and the pulse sequence measurement result is generally consistent with the real strain value. It can be seen from FIG. (c) and FIG. (f) that the two measurement results are fused by the recombination demodulation algorithm of the present disclosure, and finally, the strain measurement curve of the system can reflect the change situation of the applied dynamic strain well. Fusion results represent the demodulation results obtained by the demodulation method of this embodiment, frequency scanning represents the demodulation result obtained through pulse sequence demodulation, and LFM pulse represents the demodulation result obtained through linear frequency modulation pulse demodulation. Experiments prove that the fusion algorithm of the present disclosure can achieve strain demodulation with high resolution and large range.

### Embodiment 3

Embodiment 3 of the present disclosure provides a distributed acoustic sensing device based on a linear frequency modulation pulse sequence. The structure is basically the same as that in Embodiment 1, except that the sensing device of this embodiment further includes a calculation unit, where the calculation unit is connected to the acquisition card 12 and configured to achieve dynamic strain demodulation.

Specifically, in this embodiment, the calculation unit performs dynamic strain demodulation by the sensing method of Embodiment 2.

In conclusion, the present disclosure discloses a distributed acoustic sensing device and method based on a linear frequency modulation pulse sequence. The frequency shift and time shift features are processed by introducing the pulse recombination demodulation algorithm and the cyclic calibration related method, so that the problem of the contradiction between the maximum single strain measurement value and the strain resolution in the DAS system of the traditional linear frequency modulation pulse, and the influence of interference facing is eliminated, and the dynamic strain demodulation with high resolution and large measurement range is achieved.

Finally, it should be noted that the foregoing embodiments are merely intended for describing the technical solutions of the present disclosure, but not for limiting the present disclosure. Although the present disclosure is described in detail with reference to the foregoing embodiments, those of ordinary skill in the art should understand that they may still make modifications to the technical solutions described in the foregoing embodiments or make equivalent replacements to some or all technical features thereof, without departing from the scope of the technical solutions of the embodiments of the present disclosure.

1. A distributed acoustic sensing device based on a linear frequency modulation pulse sequence, comprising a narrow linewidth laser, a dual-parallel Mach-Zehnder modulator, a single-mode optical fiber, an arbitrary waveform generator, a balanced photodetector and an acquisition card, wherein the arbitrary waveform generator is connected to the dual-parallel Mach-Zehnder modulator, and is configured to generate a linear frequency modulation pulse sequence to drive the dual-parallel Mach-Zehnder modulator; the linear frequency modulation pulse sequence output by the arbitrary waveform generator comprises a plurality of pulses with sequentially increased or decreased central frequencies;
laser transmitted by the narrow linewidth laser is divided into two parts; one part serves as reference light, and the other part, as signal light, is modulated into the linear frequency modulation pulse sequence by the dual-parallel Mach-Zehnder modulator driven by the arbitrary waveform generator; the linear frequency modulation pulse sequence is output to a sensing optical fiber; Rayleigh backscattered light generated in the sensing optical fiber and the reference light are jointly sent to a 2*1 polarization-maintaining coupler for interference; an interference signal is detected by the balanced photodetector; and the acquisition card is configured to acquire a detection signal output by the balanced photodetector.

2. The distributed acoustic sensing device based on a linear frequency modulation pulse sequence according to claim 1, further comprising a 1*2 polarization-maintaining coupler, a first erbium-doped fiber amplifier, an optical circulator and a second erbium-doped fiber amplifier,
wherein the laser transmitted by the narrow linewidth laser is divided into two parts by the 1*2 polarization-maintaining coupler, and one part serves as the signal light and the other part serves as the reference light; the signal light is modulated into the linear frequency modulation pulse sequence by the dual-parallel Mach-Zehnder modulator driven by the arbitrary waveform generator; the linear frequency modulation pulse sequence is amplified by the first erbium-doped fiber amplifier and then output to the sensing optical fiber by the optical circulator; Rayleigh backscattered light generated in the sensing optical fiber is output by the optical circulator; and the output Rayleigh backscattered light is amplified by the second erbium-doped fiber amplifier and then sent to the 2*1 polarization-maintaining coupler together with the reference signal for interference.

3. The distributed acoustic sensing device based on a linear frequency modulation pulse sequence according to claim 1, wherein the narrow linewidth laser is configured to output laser with a central wavelength of 1550 nm.

4. The distributed acoustic sensing device based on a linear frequency modulation pulse sequence according to claim 1, wherein the linear frequency modulation pulse sequence output by the arbitrary waveform generator comprises 20 pulses with a center frequency interval of 10 MHz and a modulation bandwidth of 60 MHz.

5. The distributed acoustic sensing device based on a linear frequency modulation pulse sequence according to claim 1, wherein the arbitrary waveform generator is also connected to the acquisition card and configured to generate a trigger signal during the transmission of each linear frequency modulation pulse sequence to drive the acquisition card for data acquisition.

6. The distributed acoustic sensing device based on a linear frequency modulation pulse sequence according to claim 1, wherein the first erbium-doped fiber amplifier is a pulsed erbium-doped fiber amplifier, and the second erbium-doped fiber amplifier is a small-signal erbium-doped fiber amplifier.

7. A distributed acoustic sensing method based on a linear frequency modulation pulse sequence, implemented on the basis of the distributed acoustic sensing device based on a linear frequency modulation pulse sequence according to claim 1, and comprising the following steps:
Step 1: acquiring data by the acquisition card, and extracting a pulse sequence frequency shift matrix and a linear frequency modulation pulse time shift matrix;
Step 2: recombining the pulse sequence frequency shift matrix by a pulse recombination algorithm according to a pulse injection order to obtain a pulse sequence frequency spectrum at any optical fiber position; dividing the pulse sequence frequency spectrum into multiple segments according to time, extracting n curves within each time segment, and performing cross-correlation operation on the last curve within each time segment and a reference curve to calculate a relative frequency shift, so as to obtain a relative frequency shift quantity within each time segment; calculating a frequency shift quantity within each time segment according to the relative frequency shift quantity, and calculating an equivalent strain value according to the frequency shift quantity to obtain a first time-strain curve at each optical fiber position; calculating the average of strain values at different times as a first average value according to the obtained first time-strain curve;
Step 3: extracting a scattered signal corresponding to a single linear frequency modulation pulse in the linear frequency modulation pulse time shift matrix, determining whether the scattered signal at each position is distorted or not according to a distortion determination function, if not, performing local cross-correlation calculation by a sliding window to obtain a time shift of a signal envelope and converting the time shift into a strain value to obtain a time-strain curve at each optical fiber position, and if yes, performing interpolation calculation by the first average value obtained in Step 2 to obtain a time-strain curve at the optical fiber position; calculating the average of strain values at each optical fiber position at different times as a second average value, and subtracting the second average value from the obtained time-strain curve to obtain a second time-strain curve at each optical fiber position; repeatedly extracting scattered signals corresponding to other single linear frequency modulation pulses, performing calculation to obtain a second time-strain curve corresponding to each position, and averaging the second time-strain curves obtained through demodulation of different linear frequency modulation pulses to serve as a third time-strain curve; and
Step 4: adding the first average value to the third time-strain curve obtained in Step 3 to serve as a final strain demodulation result.

8. The distributed acoustic sensing method based on a linear frequency modulation pulse sequence according to claim 7, wherein in Step 2, the relative frequency shift is calculated by performing cross-correlation operation on the last curve within each time segment and the first curve.

9. The distributed acoustic sensing method based on a linear frequency modulation pulse sequence according to claim 7, wherein in Step 3, the distortion determination function is:
$${R}_{0} ( z - {z}_{xcorr} , z + {z}_{xcorr} ) = {\{ \frac{1}{2 k + 1} {\sum }_{i = - k}^{k} {[ {E}_{{t}_{0}} ( z - {z}_{xcorr} , z + {z}_{xcorr} ) - {E}_{{t}_{i}} ( z - {z}_{xcorr} , z + {z}_{xcorr} ) ]}^{2} \}}^{\frac{1}{2}} ,$$
wherein Rₜ_{₀} (z−z_{xcorr}, z+z_{xcorr}) represents a distortion parameter at the position z at the time t₀, k is used to specify the length of time participating in calculation and capable of being selected according to the actual calculation quantity, Eₜ_{₀} (z−z_{xcorr}, z+z_{xcorr}) represents a light intensity curve from the optical fiber position z−z_{xcorr} to the optical fiber position z+z_{xcorr} at the time t₀, Eₜ_{₁} (z−z_{xcorr}, z+z_{xcorr}) represents a light intensity curve from the optical fiber position z−z_{xcorr} to the optical fiber position z+z_{xcorr} at the time t₁, and z_{xcorr} is set as a space resolution; and
when the distortion parameter R>0.5, distortion is determined.

10. The distributed acoustic sensing method based on a linear frequency modulation pulse sequence according to claim 7, wherein in Step 2, the recombination method is as follows: extracting a Rayleigh backscattered light intensity curve I(Δv) obtained at any optical fiber position z along a frequency shift axis of the pulse sequence, and dividing and recombining data within different frequency scanning periods to obtain the pulse sequence frequency spectrum.
